(19) United States
(12) Patent Application Publication
(10) Pub. No.: US 2025/0028543 A1
(43) Pub. Date: Jan. 23, 2025

(54) SYSTEMS AND METHODS FOR GENERATING A GRAPHICAL USER INTERFACE INCLUDING AUTOMATIC AND DYNAMIC NOTIFICATIONS

(71) Applicant: BANK OF AMERICA CORPORATION, CHARLOTTE, NC (US)

(72) Inventors: Marshall Adam Johnson, Summit, NJ (US); Kevin Lin, New York, NY (US); Kathlyn Rooney, Boston, MA (US)

(73) Assignee: BANK OF AMERICA CORPORATION, CHARLOTTE, NC (US)

(21) Appl. No.: 18/776,870

(22) Filed: Jul. 18, 2024

Related U.S. Application Data
(60) Provisional application No. 63/527,919, filed on Jul. 20, 2023.

(51) Int. Cl. G06F 9/451; G06F 9/54

(52) U.S. Cl. CPC G06F 9/451; G06F 9/542

(57) ABSTRACT

Systems, computer program products, and methods are described herein for generating a graphical user interface including automatic and dynamic notifications. The present disclosure is configured to receive a trigger associated with a user account; identify user account data associated with the user account, wherein the user account data comprises at least one of a historical data or real time data; identify at least one similar user account based on the at least one similar user account comprising at least one similar historical data or similar real time data; generate a dynamic user account notification interface component, wherein the dynamic user account notification interface component comprises user account data; and transmit the dynamic user account notification interface component to a user device associated with the user account.

### CROSS-REFERENCE TO RELATED APPLICATIONS

This application claims the benefit of U.S. Provisional Patent Application No. 63/527,919, filed Jul. 20, 2023, entitled “Systems And Methods For Generating a Graphical User Interface Including Automatic and Dynamic Notifications”, the entirety of which is incorporated herein by reference.

### TECHNOLOGICAL FIELD

Example embodiments of the present disclosure relate to generating a graphical user interface including automatic and dynamic notifications.

### BACKGROUND

There exists a need for graphical user interfaces to have automatic and dynamic notifications based on real time determinations of a system that are tailored to a user account's preferences, goals, current data, geolocation, and/or the like.

Applicant has identified a number of deficiencies and problems associated with generating a graphical user interface with automatic and dynamic notifications. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for generating a graphical user interface including automatic and dynamic notifications.

In one aspect, a system for generating a graphical user interface including automatic a dynamic notifications is provided. In some embodiments, the system may comprise: a memory device with computer-readable program code stored thereon; at least one processing device, wherein executing the computer-readable code is configured to cause the at least one processing device to perform the following operations: receive a trigger associated with a user account; identify user account data associated with the user account, wherein the user account data comprises at least one of a historical data or real time data; identify at least one similar user account based on the at least one similar user account comprising at least one similar historical data or similar real time data; generate a dynamic user account notification interface component, wherein the dynamic user account notification interface component comprises user account data; and transmit the dynamic user account notification interface component to a user device associated with the user account.

In some embodiments, the system may further comprise update the dynamic user account notification interface component with at least one tailored insight based on user account data or at least one user account preference; and transmit the updated dynamic user account notification interface component to the user device associated with the user account.

In some embodiments, the system may further comprise update the dynamic user account notification interface component with at least the real time data of the user account data and at least one recommendation based on the real time data. In some embodiments, the updated dynamic user account notification interface component comprises at least one of a user provided goal or a user provided prioritization.

In some embodiments, the system may further comprise generate an optimization allocation interface component based on the historical user account data and the real time data, wherein the optimization allocation interface component comprises at least one allocation suggestion based on the similar user account data.

In some embodiments, the system may further comprise generate a resiliency meter based on user account data of the user account, wherein the resiliency meter comprises a threat assessment score of the user account for at least one threat type. In some embodiments, the system may further comprise: identify at least one threat minimization allocation associated with the user account; and update the resiliency meter and the threat assessment score based on the at least one threat minimization allocation.

In some embodiments, the at least one similar user account is associated with the user account based on a shared association attribute. In some embodiments, the system may further comprise: map the user account to the at least one similar user account; identify at least one allocation milestone for at least one of the similar user account or the user account; and determine whether the at least one allocation milestone has been met by the at least one of the similar user account or the user account, wherein, in response to the at least one of the similar user account meeting the at least one allocation milestone, generate a milestone notification interface component and transmit the milestone notification interface component to a user device of the at least one similar user account, or wherein, in response to the user account meeting the at least one allocation milestone, generate a milestone notification interface component and transmit the milestone notification interface component to the user device of the user account.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating a graphical user interface including automatic and dynamic notifications, in accordance with an embodiment of the disclosure;

FIG. 2 illustrates a process flow for generating a graphical user interface including automatic and dynamic notifications, in accordance with an embodiment of the disclosure;

FIG. 3 illustrates a process flow for generating and transmitting the updated dynamic user account notification interface component, in accordance with an embodiment of the disclosure;

FIG. 4 illustrates a process flow for updating the dynamic user account notification interface component with at least the real time data of the user account data and at least one recommendation, in accordance with an embodiment of the disclosure;

FIG. 5 illustrates a process flow for generating an optimization allocation interface component based on the historical user account data and the real time data, in accordance with an embodiment of the disclosure;

FIG. 6 illustrates a process flow for generating and updating a resiliency meter based on user account data, in accordance with an embodiment of the disclosure; and

FIG. 7 illustrates a process flow for generating and transmitting a milestone notification interface component, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” “resource transmission,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

There exists a need for graphical user interfaces to have automatic and dynamic notifications based on real time determinations of a system that are tailored to a user account's preferences, goals, current data, geolocation, and/or the like. For example, a system is needed to analyze data of a user account (such as historical resource transmission data, historical resource saving data, historical resource investment data, current resource transmission data, current resource saving data, current resource investment data, and/or the like), preferences input by the user account (including identifications of what are considered by the user to most important and least important for resource transmissions), goals of the user, and/or the like. Based on this data, a system is needed to generate informed decisions on what to suggest for the user account in order to meet the user account's future needs or goals. Such informed decisions must further be indicated using push notifications that are dynamically generated in real time and based on current or real time data.

Accordingly, the present disclosure provides may avenues of solving the above-identified problems. For instance and at a high level, the present disclosure provides a system configured to receive a trigger associated with a user account (e.g., indicating that the user account would like to opt in to receiving recommendations or suggestions by the system); identify user account data associated with the user account, wherein the user account data comprises at least one of a historical data or real time data (current data); identify at least one similar user account based on the at least one similar user account comprising at least one similar historical data or similar real time data (e.g., similar resource transmissions, similar categorizations, similar goals or preferences, similar physical characteristics, similar geolocation, and/or the like); generate a dynamic user account notification interface component, wherein the dynamic user account notification interface component comprises user account data (e.g., and suggestions or recommendations for the user based on the user account data and the similar user account data); and transmit the dynamic user account notification interface component to a user device associated with the user account.

What is more, the present disclosure provides a technical solution to a technical problem. As described herein, the technical problem includes the generation of GUIs including automatic and dynamic notifications. The technical solution presented herein allows for the informed generation of GUIs including automatic and dynamic notifications for a user account based on historical and/or real time data. In particular, the system is an improvement over existing solutions to the generation of notifications on a GUI, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

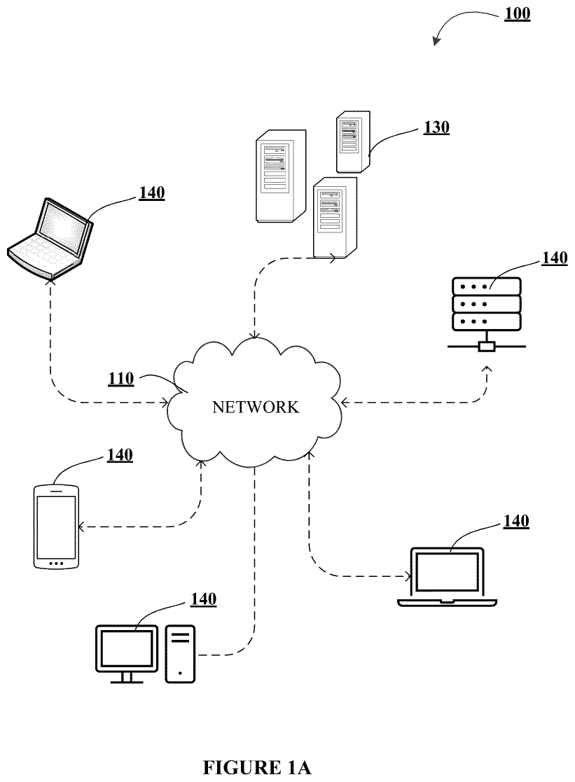

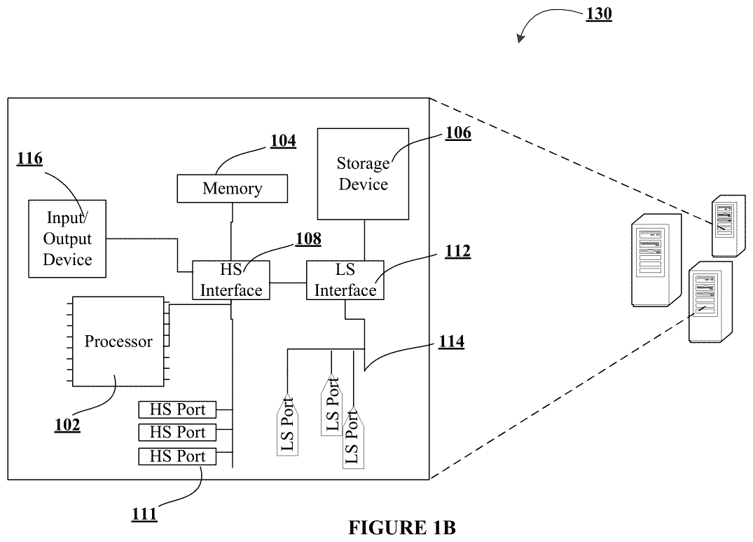

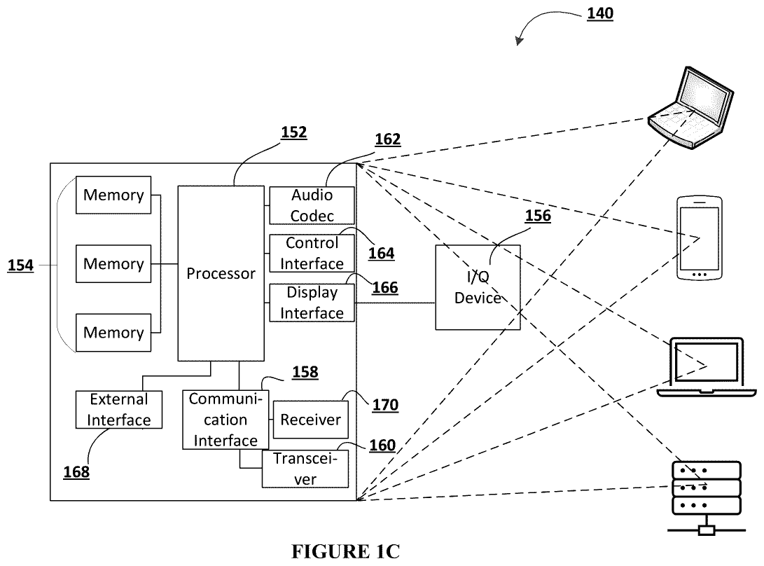

FIGS. 1A-IC illustrate technical components of an exemplary distributed computing environment for generating a graphical user interface including automatic and dynamic notifications 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

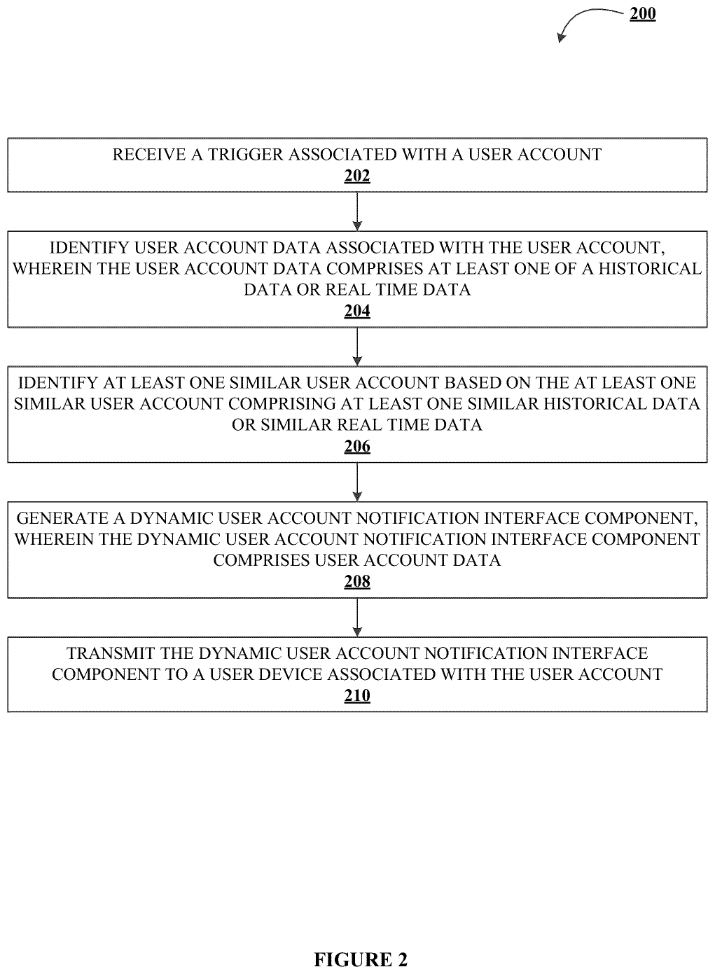

FIG. 2 illustrates a process flow for generating a graphical user interface including automatic and dynamic notifications, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of receiving a trigger associated with a user account. Such a trigger may be provided by the system itself, based on reviewing the user account data of the user account, or provided by the user of the user account by interacting with the system and/or by inputting a user interaction transmitted to the system. For instance, the user of the user account may indicate—through an interaction, such as by submitting a request to the system—that the user wishes to be considered by the system and receive push notifications via configured or generated graphical user interfaces (GUIs). Such push notifications may be generated based on the user account, including the real time user account data and/or historical user account data. Such embodiments of what push notifications may comprise and/or indicate are described in further detail below.

As shown in block 204, the process flow 200 may include the step of identifying user account data associated with the user account, wherein the user account data comprises at least one of a historical data or real time data. For instance, such historical data may comprise all the data (including but not limited to historical resource transactions, historical resource storage and accounts, historical resource investments, and/or the like) of the user account up to the current time. Further, and in some embodiments, the system may additionally and/or alternatively identify real time data of the user account at a current time, such as by tracking each of the current and/or pending resource transactions, current resource storage accounts, current resource investments, and/or the like.

As shown in block 206, the process flow 200 may include the step of identifying at least one similar user account based on the at least one similar user account comprising at least one similar historical data or similar real time data. The system may identify at least one similar user account based on the identification of similar historical data, similar real time data (e.g., similar resource account data, similar resource storage account data, similar investment account data, and/or the like), similar data regarding the user of the user account (such as physical characteristics, geographic location, objectives/goals, and/or the like), and/or the like.

As shown in block 208, the process flow 200 may include the step of generating a dynamic user account notification interface component, wherein the dynamic user account notification interface component comprises user account data. The system may generate a dynamic user account notification interface component, which may comprise a data packet of data that is used to render or configure a GUI on a user device with viewable data. Such viewable data may be generated by the data packet of the dynamic user account notification interface component in order to show human-readable information on a GUI of a user device, and such a dynamic user account notification interface component may be dynamically and automatically generated based on a trigger identified by the system, based on an alert generated by the system, based on data gathered by the system, and/or the like. Such embodiments of the dynamic user account notification interface component are described in further detail below.

As shown in block 210, the process flow 200 may include the step of transmitting the dynamic user account notification interface component to a user device associated with the user account. Similarly, and as described above, the system may transmit the dynamic user account notification interface component to a user device (such as a user device associated with the user account and/or a user device associated with a similar user account to the user account), whereby the dynamic user account notification interface component may then configure the GUI of the user device dynamically and/or automatically.

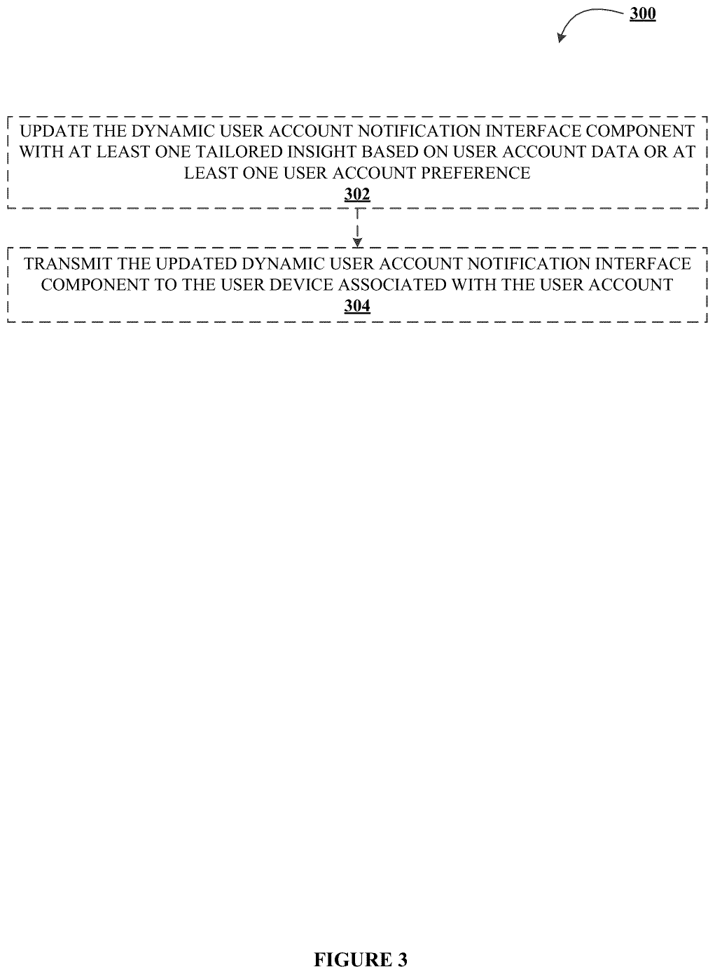

FIG. 3 illustrates a process flow for generating and transmitting the updated dynamic user account notification interface component, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

As shown in block 302, the process flow 300 may include the step of updating the dynamic user account notification interface component with at least one tailored insight based on user account data or at least one user account preference. For example, the system may update the dynamic user account notification interface component with a tailored insight, such as a tailored insight as to what a user should do with their resource account(s). Such tailored insights, in some embodiments, may be based on the user account data, the user preferences (e.g., what is important and what is discretionary), the user account's goals, the user account's categorization of resource transmissions, and/or the ranking of importance for the user account's resource transmissions.

In some embodiments, the system itself may categorize historical and real time data, such as historical resource transmissions and current resource transmissions, and based on such categorizations, the system may generate suggestions or recommendations for the user account. In some embodiments, the suggestions or recommendations may comprise resource thresholds or resource maximums the user account should abide by for each resource transmission category. In some further embodiments, the system may automatically identify resource saving mechanisms and strategies for the user account, and for each of the categories, and transmit the resource saving mechanisms and strategies as an interface component (e.g., an updated dynamic user account notification interface component) to show the user via the configured GUI on the user's device the mechanisms and strategies.

As shown in block 304, the process flow 300 may include the step of transmitting the updated dynamic user account notification interface component to the user device associated with the user account. Thus, and as described above, the system may generate the updated dynamic user account notification interface component to comprise hyper-personalized recommendations or suggestions for the user based on the user account's data (historical and/or real time).

In some further embodiments, the system may—in real time and dynamically—determine different categories of the resource transmissions that could be pulled from and/or dynamically changed in order to allow the user to go over their resource threshold elsewhere (e.g., in other categories). For example, the system may limit certain resources dynamically and automatically in order to allow a higher resource threshold for more important resource transmission categories.

In some embodiments, the system may generate different interface components to configure the GUI of the user device in order to indicate to the user of the user account how close or how far the user is from meeting the resource threshold for each of the categories, and provided positive or negative feedback to the user via the configured GUIs.

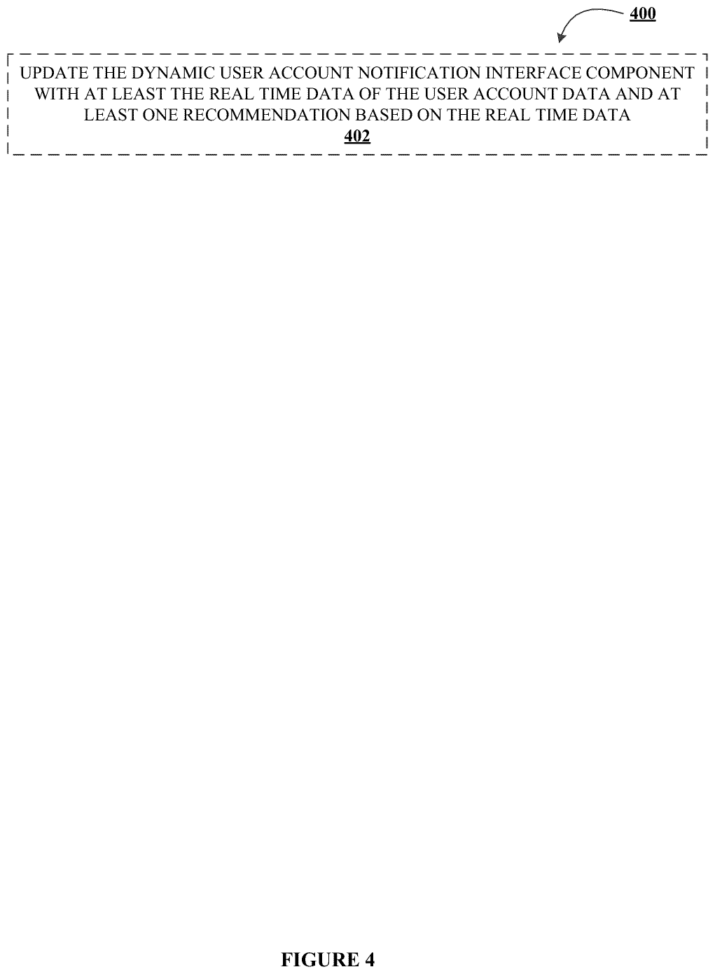

FIG. 4 illustrates a process flow for updating the dynamic user account notification interface component with at least the real time data of the user account data and at least one recommendation, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

As shown in block 402, the process flow 400 may include the step of updating the dynamic user account notification interface component with at least the real time data of the user account data and at least one recommendation based on the real time data. For instance, and in some embodiments, the system may update the dynamic user account notification interface component with at least the real time data of the user account data and/or the historical data for the user account data and at least one recommendation based on such data. Such a recommendation may be generated by the system using the data of the user account including but not limited resource transmission(s), resource storage, resource investment(s), and in some embodiments geographic locations, physical characteristics of the user, and/or the like.

In some embodiments, the dynamic user account notification interface component and its associated recommendation(s) may additionally and/or alternatively be based on user-provided preferences and/or prioritizations. For instance, the updated dynamic user account notification interface component may comprise at least one of a user provided goal or a user provided prioritization (e.g., which may indicate what is discretionary and what is important to the user account). In some embodiments, the prioritization may be identified by a ranking of the resource transmissions, and/or the like. For example, and as described herein, the user account may provide a prioritization and/or preference of particular resource transmissions and the recipient of the resource transmissions to the system, such that the system may determine whether to suggest to the user account—via the dynamic user account notification interface component—to no longer make the resource transmissions and/or to always make the resource transmissions (e.g., where a resource transmission is ranked very low, the system may suggest or recommend that the resource transmission be abstained from).

As described herein, the dynamic user account notification interface component may comprise tailored insights (such as tailored resource insights) for the user account based on the user account's individualized data (historical and real time) and preferences/prioritizations. Such a dynamic user account notification interface component may be generated automatically and dynamically upon the identification of the resource transmissions and/or based on the identification of prioritizations/preferences.

In some embodiments, the system may categorize the resource storage accounts and other such resource accounts for the user account, and may categorize resource transmissions based on individualized and personalized inputs by the user. Such categorizations may then be used by the system in generating the recommendation(s). In some embodiments, the categorizations may further comprise a maximum and/or threshold provided by the user and/or generated by the system, such that only a certain threshold of resources may be used within a set period of time for each categorization. In some embodiments, the categories may additionally be ranked and/or may comprise their own prioritizations and/or preferences (e.g., a utility categorization for a resource transmission may be ranked highest of importance by the user).

In some embodiments, the system may dynamically determine different categories of resource transmissions that could be pulled from and/or dynamically changed in order to allow the user to go over their resource threshold for that important category, while limiting other resource categories. In this manner, the user account may be able to move around the resource threshold or resource maximum for each resource category in order to not exceed an overall resource threshold or resource maximum for all the categories.

Further, and in some embodiments, the system may generate different interface components to configure the GUIs of the user device(s) to show how close the user account and their associated resource accounts are to hitting the resource threshold, in real-time, and to provide positive and/or negative feedback to the user. In some embodiments, the system may generate alerts to the user so the user is made aware of their resource accounts and resource threshold(s). In some embodiments, the GUI generated and/or configured by the system may be part of a simulation within a virtual reality (VR) environment or augmented reality (AR) environment.

In some embodiments, the system may additionally and/or alternatively automatically transfer or transmit a resource upon some triggering event or threshold, such as where the user account wishes to keep a certain threshold resource amount within a resource storage account. Such an automatic re-transmission and/or block of a transmission may occur to make sure this threshold is followed and not exceed (e.g., to make sure the resource account always has a certain threshold of a resource accessible). Such a threshold resource amount may be based on a user provided input, by an input provided by a client of the system, and/or by an input provided by a manager of the system.

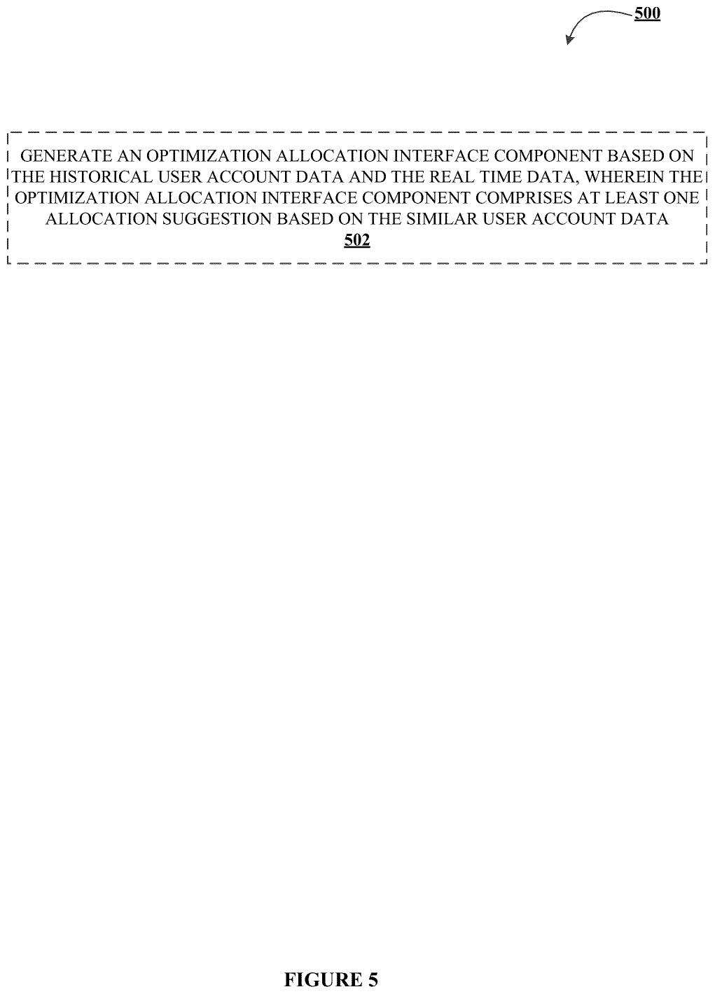

FIG. 5 illustrates a process flow for generating an optimization allocation interface component based on the historical user account data and the real time data, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

As shown in block 502, the process flow 500 may include the step of generating an optimization allocation interface component based on the historical user account data and the real time data, wherein the optimization allocation interface component comprises at least one allocation suggestion based on the similar user account data. For example, the system may generate an optimization allocation interface component based on the historical user account data and/or the real time data of the user account, such that the optimization allocation interface component comprises data for the user account/the user to show optimization strategies and/or optimization recommendations for the user account's resource accounts. For instance, and in some embodiments, the system may use the comparable data of the similar user account data (e.g., the similar user accounts based on resource accounts, physical characteristics, goals, preferences, geological location, and/or the like) to generate optimization strategies and/or recommendations that the user account may follow in order to optimize their resource accounts.

For example, and in some embodiments, the system may track the similar user account(s) and the associated similar user account data to determine what the similar user account(s) are doing and what is working for the similar user account goals and/or resource account optimizations and what is not working. Based on this tracking, the system may then generate suggestions and/or recommendations to the [primary] user account for what the user account should be doing and/or should not be doing in transmitting resources and the resource data.

In some embodiments, the system may generate a user account assessment in order to determine what resource behaviors and/or patterns the user account has been following, what behaviors and/or patterns may be changed based on their individual impacts on the user account and associated resource account(s). For example, the system may be configured to analyze a user account's various subscriptions, track usage of the user account's subscriptions (including what are most often used and what are least often used), and generate suggestions of a resource transmission behavior change that will impact the user account's resource account(s) in a positive way.

In some embodiments, the system may also help when user account comprises resource transmissions that appear to coincide with an event (such as a negative event), and may generate suggestions to help the user account and the associated resource account behaviors improve. For instance, and when the resource account transmissions appear to be going in a negative direction, the system may generate automatic push notifications—via the optimization allocation interface component—that is used to configure the GUI of the user device to indicate what behavior is positive, what behavior is negative, and/or to generate a positive feedback notification when good behavior is followed. Such notifications may comprise pictures and/or graphics configured on the GUI of the user device, a vibration of the user device, a noise by the microphone of the user device, and/or the like. In some embodiments, the system may be trained to determine what positive feedback would most likely have the greatest impact on the user, such as a positive feedback comprising a graphic that will bring the user joy.

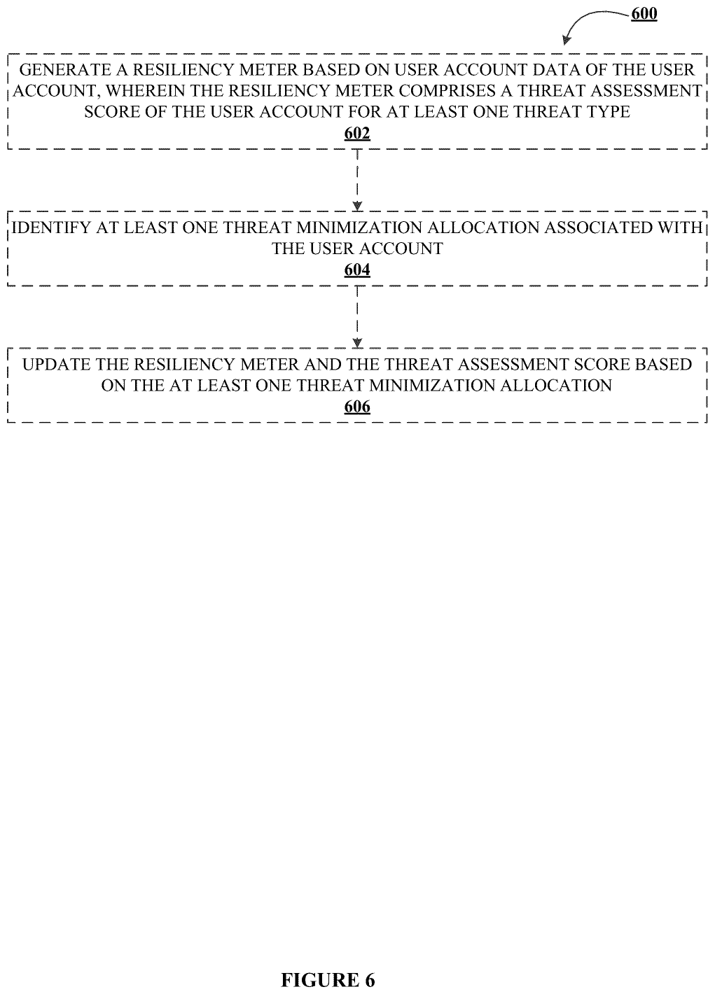

FIG. 6 illustrates a process flow for generating and updating a resiliency meter based on user account data, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600.

As shown in block 602, the process flow 600 may include the step of generating a resiliency meter based on user account data of the user account, wherein the resiliency meter comprises a threat assessment score of the user account for at least one threat type. For example, the system may generate a resiliency meter which indicates how resilient the user account and its associated resource accounts are to a potential negative event, and whether the user account and its associated resource accounts will be able to make it through the potential negative event without hitting a zero balance and/or a negative balance in the resource account(s). As used herein, the resiliency meter refers to a determination of the user account's ability to withstand a threat if it were to happen at a predicted time and/or in real time (at a current time). As used herein, the threat assessment score refers to a user account's likelihood of a threat (e.g., such as the user losing their job, having an emergency event, and/or the like), and at what time the potential threat could occur.

For example, such potential negative events may be tracked and generated in a simulated environment by the system, and the real time and/or historical data of the resource account(s) may be used to simulate the user account's likely actions in the event of the potential negative event. Based on such real time and/or historical data may be used by the system to generate a likelihood and/or a score, such as threat assessment score, whereby the score may be used to indicate a finite prediction of the user account's ability to make it through the potential negative event.

As shown in block 604, the process flow 600 may include the step of identifying at least one threat minimization allocation associated with the user account. For example, the system may identify at least one threat minimization allocation associated with the user account, whereby the threat minimization allocation may be based on the user account's data (e.g., historical and/or real time, physical characteristic(s), goal(s), geolocation, and/or the like) and may indicate a suggested resource allocation that the user account may follow in order to minimize the threat or likelihood of the user account (and associated resource account(s)) not making it through the potential negative event.

In some embodiments, the system may automatically follow the threat minimization allocation and conduct a resource transmission based on the threat minimization allocation, without waiting for express and/or prior approval from the user account.

In some embodiments, the system may additionally and/or alternatively, update the resiliency meter to show a suggested or outcome of the resiliency meter if the user account were to follow the threat minimization allocation, including the potential negative and/or positive effect of the threat minimization allocation on the threat assessment score.

As shown in block 606, the process flow 600 may include the step of updating the resiliency meter and the threat assessment score based on the at least one threat minimalization allocation. For instance, the system may update the resiliency meter based on the threat assessment score, such that the updated threat assessment score shows the outcome of following the threat minimization allocation. In some embodiments, the threat assessment score may additionally and/or alternatively be updated to show a simulated threat assessment score if the threat minimization allocation is not followed, including time periods.

In some embodiments, the system may use such data and the generated the resiliency meter and threat assessment score to show a user (via a configuration of a GUI of the user's device) potential threats the user may face at a future time, how their actions today may affect their future selves (how their resource transmissions today may affect their future resource accounts). Further, and in some embodiments, the system may further be configured to generate notifications (e.g., interface components like those described herein) which are used to indicate when the user is showing good or positive behavior with respect to their resource accounts and resource transmissions (e.g., the resiliency meter may increase as positive behavior is tracked).

In some embodiments, the resiliency meter may additionally and/or alternatively comprise or generate suggestions for the user account based on the current resiliency meter and current threat assessment score, whereby such a suggestion(s) may comprise pathways and/or metrics the user account may want to follow to increase the resiliency meter. In some such embodiments, the suggestion(s) may comprise individualized steps and/or pathways that break down the suggestion into a step-by-step process. In some embodiments, the suggestion(s) may comprise a resource effect, which may indicate the amount and/or value of the resource at a future period (such as based on historical data).

In some embodiments, the system may also show—based on historical and/or real time data—what the future value of the resource(s) may be and whether the user account will be able to handle future events based on the predicted value of the resource(s). Further, and in some embodiments, the system may generate a likelihood that the user may provide a mechanism to determine a likelihood the user may go beyond their resources based on historical data. In some embodiments, the system may generate an interface component to show—via configuration of a GUI on a user device—each of the likelihoods of potential threats and or events and a potential timeline of each, whereby such an interface component may further comprise push notification which may comprise haptics, vibrations, sounds, and/or the like.

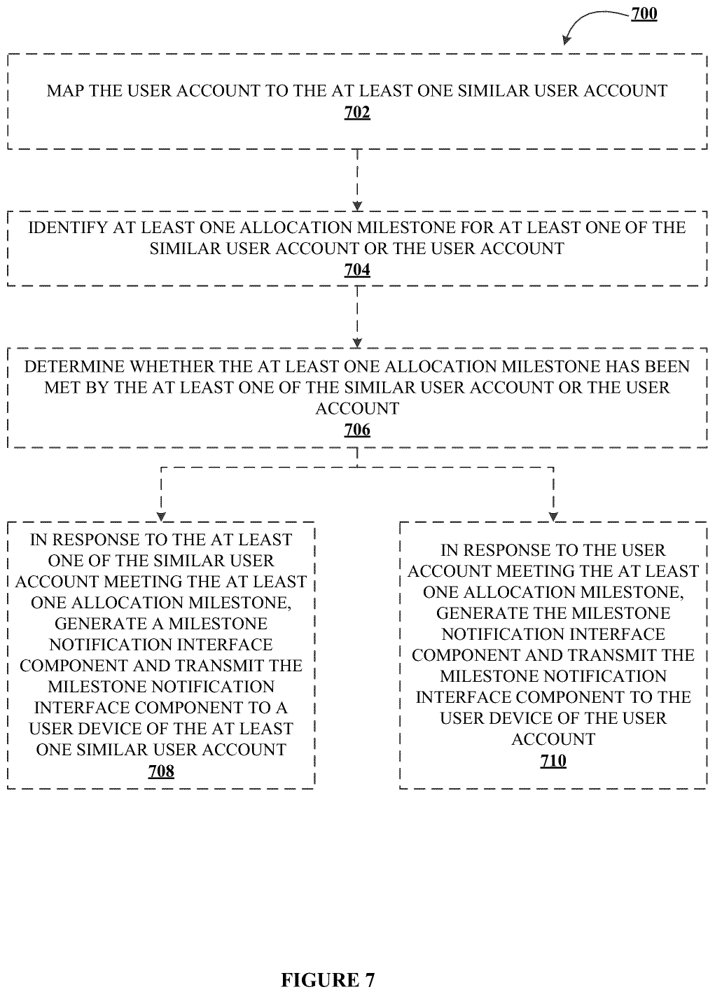

FIG. 7 illustrates a process flow for generating and transmitting a milestone notification interface component, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700.

As shown in block 702, the process flow 700 may include the step of mapping the user account to the at least one similar user account. For example, the system may map and/or link associated user accounts (such as a primary user account to other such similar user accounts and/or other such user accounts that are often in communication with the primary user account by email, text, phone calls, and/or the like, and/or by relationship such as familial or friend relationships) within its database, such that each of the user accounts that should be mapped or linked together have at least one same attribute and/or identifier. In this manner, the system may identify constant communications and/or relationships and may track each of the user accounts and compare the associated resource data for each of the user accounts.

In some embodiments, and by mapping and/or the linking the user accounts (e.g., such as the user account with similar user account(s) which are identified as having a relationship), the system may generate a shared associated attribute (which may be stored in a database with an identifier of each of the user accounts) and/or identifier, and may be used to indicate a relationship between each of the user accounts. In some embodiments, the relationship may be based on an identified competition between the user account and other user accounts (e.g., similar user accounts).

As shown in block 704, the process flow 700 may include the step of identifying at least one allocation milestone for at least one of the similar user account or the user account. For example, the at least one allocation milestone, as described herein, may refer to a goal and/or objective shared by the user accounts in the relationships and sharing the shared association attribute. Further, and as used herein, the system may identify this at least one allocation milestone as a milestone for resource accounts of the user accounts, whereby when certain actions by a user account is taken, the user account may get closer or farther from the allocation milestone.

As shown in block 706, the process flow 700 may include the step of determining whether the at least one allocation milestone has been met by the at least one of the similar user account or the user account. For example, the system may determine whether the at least one allocation milestone has been met by the user accounts by tracking the data of each of the resource account(s) of the user accounts within the identified relationship (whereby each of the user accounts may be part of the relationship based on the allocation milestone(s) they share).

As shown in block 708, the process flow 700 may include the step of generating—in response to the at least one of the similar user account meeting the at least one allocation milestone—a milestone notification interface component and transmitting the milestone notification interface component to a user device of the at least one similar user account. For example, the system may generate—upon determining a similar or other user account is getting closer to and/or getting further away from an allocation milestone—a milestone notification interface component, which may be used to configure a GUI of the similar user account's user device to indicate how close or far the similar user account is from the allocation milestone. In some embodiments, and upon determining an allocation milestone has been met by a similar user account, the system may generate the milestone notification interface component to configure all of the GUIs of the user devices associated with all of the user accounts of the allocation milestone, and/or only the GUI of the similar user device that met the allocation milestone.

As shown in block 710, the process flow 700 may include the step of generating—in response to the user account meeting the at least one allocation milestone—the milestone notification interface component and transmitting the milestone notification interface component to the user device of the user account. For instance, the system may generate the notification interface component comprising a data packet indicating whether the allocation milestone was met, which user account(s) that met the allocation milestone, and/or the like. Similar to the GUI interface components described above with respect to a similar user account meeting an allocation milestone, the system may additionally and/or alternatively generate the milestone notification interface component to configure all of the GUIs of the user devices associated with all of the user accounts to indicate the allocation milestone has not been met by the [primary] user accounts, and/or the system may only configure a GUI of the user device associated with the [primary] user account that met the allocation milestone.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating a graphical user interface including automatic dynamic notifications, the system comprising:
a memory device with computer-readable program code stored thereon;
at least one processing device, wherein executing the computer-readable code is configured to cause the at least one processing device to perform the following operations:
receive a trigger associated with a user account;
identify user account data associated with the user account, wherein the user account data comprises at least one of a historical data or real time data;
identify at least one similar user account based on the at least one similar user account comprising at least one similar historical data or similar real time data;
generate a dynamic user account notification interface component, wherein the dynamic user account notification interface component comprises user account data; and
transmit the dynamic user account notification interface component to a user device associated with the user account.

2. The system of claim 1, wherein the system further comprises:
update the dynamic user account notification interface component with at least one tailored insight based on user account data or at least one user account preference; and
transmit the updated dynamic user account notification interface component to the user device associated with the user account.

3. The system of claim 1, wherein the system further comprises:
update the dynamic user account notification interface component with at least the real time data of the user account data and at least one recommendation based on the real time data.

4. The system of claim 3, wherein the updated dynamic user account notification interface component comprises at least one of a user provided goal or a user provided prioritization.

5. The system of claim 1, wherein the system further comprises:
generate an optimization allocation interface component based on the historical user account data and the real time data, wherein the optimization allocation interface component comprises at least one allocation suggestion based on the similar user account data.

6. The system of claim 1, wherein the system further comprises:
generate a resiliency meter based on user account data of the user account, wherein the resiliency meter comprises a threat assessment score of the user account for at least one threat type.

7. The system of claim 6, wherein the system further comprises:
identify at least one threat minimization allocation associated with the user account; and
update the resiliency meter and the threat assessment score based on the at least one threat minimization allocation.

8. The system of claim 1, wherein the at least one similar user account is associated with the user account based on a shared association attribute.

9. The system of claim 8, wherein the system further comprises:
map the user account to the at least one similar user account;
identify at least one allocation milestone for at least one of the similar user account or the user account; and
determine whether the at least one allocation milestone has been met by the at least one of the similar user account or the user account,
wherein, in response to the at least one of the similar user account meeting the at least one allocation milestone, generate a milestone notification interface component and transmit the milestone notification interface component to a user device of the at least one similar user account, or
wherein, in response to the user account meeting the at least one allocation milestone, generate a milestone notification interface component and transmit the milestone notification interface component to the user device of the user account.

10. A computer program product for generating a graphical user interface including automatic dynamic notifications, wherein the computer program product comprises at least one non-transitory computer-readable medium having computer-readable program code portions embodied therein, the computer-readable program code portions which when executed by a processing device are configured to cause the processor to perform the following operations:
receive a trigger associated with a user account;
identify user account data associated with the user account, wherein the user account data comprises at least one of a historical data or real time data;
identify at least one similar user account based on the at least one similar user account comprising at least one similar historical data or similar real time data;
generate a dynamic user account notification interface component, wherein the dynamic user account notification interface component comprises user account data; and
transmit the dynamic user account notification interface component to a user device associated with the user account.

11. The computer program product of claim 10, wherein the processing device is configured to cause the processor to:
update the dynamic user account notification interface component with at least one tailored insight based on user account data or at least one user account preference; and
transmit the updated dynamic user account notification interface component to the user device associated with the user account.

12. The computer program product of claim 10, wherein the processing device is configured to cause the processor to:
update the dynamic user account notification interface component with at least the real time data of the user account data and at least one recommendation based on the real time data.

13. The computer program product of claim 10, wherein the processing device is configured to cause the processor to:
generate an optimization allocation interface component based on the historical user account data and the real time data, wherein the optimization allocation interface component comprises at least one allocation suggestion based on the similar user account data.

14. The computer program product of claim 10, wherein the at least one similar user account is associated with the user account based on a shared association attribute.

15. The computer program product of claim 14, wherein the processing device is configured to cause the processor to:
map the user account to the at least one similar user account;
identify at least one allocation milestone for at least one of the similar user account or the user account; and
determine whether the at least one allocation milestone has been met by the at least one of the similar user account or the user account,
wherein, in response to the at least one of the similar user account meeting the at least one allocation milestone, generate a milestone notification interface component and transmit the milestone notification interface component to a user device of the at least one similar user account, or
wherein, in response to the user account meeting the at least one allocation milestone, generate a milestone notification interface component and transmit the milestone notification interface component to the user device of the user account.

16. A computer implemented method for generating a graphical user interface including automatic dynamic notifications, the computer implemented method comprising:
receiving a trigger associated with a user account;
identifying user account data associated with the user account, wherein the user account data comprises at least one of a historical data or real time data;
identifying at least one similar user account based on the at least one similar user account comprising at least one similar historical data or similar real time data;
generating a dynamic user account notification interface component, wherein the dynamic user account notification interface component comprises user account data; and
transmitting the dynamic user account notification interface component to a user device associated with the user account.

17. The computer implemented method of claim 16, the computer implemented method further comprising:
updating the dynamic user account notification interface component with at least one tailored insight based on user account data or at least one user account preference; and
transmitting the updated dynamic user account notification interface component to the user device associated with the user account.

18. The computer implemented method of claim 16, the computer implemented method further comprising:
updating the dynamic user account notification interface component with at least the real time data of the user account data and at least one recommendation based on the real time data.

19. The computer implemented method of claim 16, the computer implemented method further comprising:
generating an optimization allocation interface component based on the historical user account data and the real time data, wherein the optimization allocation interface component comprises at least one allocation suggestion based on the similar user account data.

20. The computer implemented method of claim 16, wherein the at least one similar user account is associated with the user account based on a shared association attribute, and wherein the computer implemented method further comprises:
mapping the user account to the at least one similar user account;
identifying at least one allocation milestone for at least one of the similar user account or the user account; and
determining whether the at least one allocation milestone has been met by the at least one of the similar user account or the user account,
wherein, in response to the at least one of the similar user account meeting the at least one allocation milestone, generating a milestone notification interface component and transmitting the milestone notification interface component to a user device of the at least one similar user account, or
wherein, in response to the user account meeting the at least one allocation milestone, generating a milestone notification interface component and transmitting the milestone notification interface component to the user device of the user account.
